(19) United States
(12) Patent Application Publication
(10) Pub. No.: US 2025/0270893 A1
(43) Pub. Date: Aug. 28, 2025

(54) SYSTEMS AND METHODS FOR SEALING A WELLBORE

(71) Applicant: Schlumberger Technology Corporation, Sugar Land, TX (US)

(72) Inventors: Lukasz Zielinski, Cambridge, MA (US); Manasi Doshi, Cambridge, MA (US); Mathieu Dauphin, Cambridge, MA (US)

(21) Appl. No.: 19/059,449

(22) Filed: Feb. 21, 2025

Related U.S. Application Data
(60) Provisional application No. 63/556,968, filed on Feb. 23, 2024.

(51) Int. Cl. E21B 33/13; E21B 33/12

(52) U.S. Cl. CPC E21B 33/13; E21B 33/12

(57) ABSTRACT

A method for sealing a wellbore is provided. The method includes positioning a tool including a radiation emitting device in a wellbore at a desired depth, emitting electromagnetic radiation at one or more frequencies, emitting the electromagnetic radiation includes emitting the electromagnetic radiation in a radial direction towards geological material disposed in the wellbore, melting the geological material with the electromagnetic radiation, and sealing at least a portion of the wellbore with the melted geological material.

### CROSS-REFERENCE TO RELATED APPLICATION

This application claims the benefit of U.S. Provisional Patent Application No. 63/556,968, filed Feb. 23, 2024, which is incorporated by reference herein in its entirety.

### BACKGROUND

The present disclosure generally relates to well-scaling operations in the Oil & Gas industry. Cement is often used to seal wellbores in Oil & Gas operations. The cement is oftentimes pumped downhole to seal portions of the wellbore. In a few non-limiting examples, cement may be used for zonal isolation and cement may be used in permanently scaling (e.g., plugging) a well. In the case of zonal isolation, cement is pumped into an annular space between the casing and the wellbore to isolate zones of a multiple zone well (e.g., seal the wall of a wellbore). In the case of permanently sealing (e.g., plugging) a well, such as in plug-and-abandon (P&A) operations, a cement plug is pumped to fill the entire cross section of a well in order to close off all fluid communication between the downhole fluids and the surface.

In either application, cement provides a highly unreliable and often short-lived seal. First, it is difficult to ensure a good bond between the cement and the formation as well as any hardware within the wellbore. Similarly, seal quality may be compromised due to bypass regions or channeling due to washouts, accumulated cuttings or iron filings, any incompatible fluids (e.g., oil-based mud) left in the borehole prior to the cement job.

Further, even a perfectly planned and executed cement job is not a guarantee of long-term seal integrity. Cement may react with the formation fluids and environmental factors, such as changes in temperature and pressure. Such interactions will cause the cement to degrade with time, eventually cracking and crumbling. In particular, CO₂-rich environments, such as those found in the subsurface under large-scale CO₂-sequestration projects, will be especially aggressive at degrading cement both chemically and mechanically.

While various non-cementitious materials such as resins have been proposed as alternatives, they are not widely deployed and their long-term integrity and scaling performance in downhole conditions is poorly understood. Finally, a cementing job itself has a large carbon footprint, as the cement manufacturing process is highly carbon-intensive, as is its transport and eventual placement.

Accordingly, as there is a need for improved systems and methods for various well-sealing operations which, not only are long-lasting, but are also cost-effective and environmentally friendly.

### SUMMARY

Aspects of the present disclosure provide a method for sealing a wellbore. The method includes positioning a tool including a radiation emitting device in a wellbore at a desired depth, emitting electromagnetic radiation at one or more frequencies, emitting the electromagnetic radiation includes emitting the electromagnetic radiation in a radial direction towards geological material disposed in the wellbore, melting the geological material with the electromagnetic radiation, and sealing at least a portion of the wellbore with the melted geological material.

Aspects of the present disclosure provide a system for sealing a wellbore. The system including a radiation generator configured to generate electromagnetic radiation, a radiation transmitter coupled to the radiation generator for transmitting the electromagnetic radiation, and a radiation emitting device configured to emit the electromagnetic radiation in a radial direction towards geological material in a wellbore to melt the geological material.

### BRIEF DESCRIPTION OF DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments. It is emphasized that, in accordance with the standard practice in the industry, various features are not drawn to scale. In fact, the dimensions of the various features may be arbitrarily increased or reduced for clarity of discussion.

FIG. 1A illustrates an exemplary well-sealing system, according to one or more embodiments.

FIG. 1B illustrates another exemplary well-sealing system, according to one or more embodiments.

FIGS. 2A-2B schematically illustrate a radiation emitting device emitting electromagnetic radiation to melt geological material, according to one or more embodiments.

FIGS. 3A-3C illustrate exemplary radiation emitting devices, according to one or more embodiments.

FIG. 4 illustrates another exemplary well-sealing system, according to one or more embodiments.

FIG. 5 illustrates a method for sealing a wellbore, according to one or more embodiments.

FIG. 6 illustrates a method for plugging a wellbore, according to one or more embodiments.

FIG. 7A schematically illustrates an exemplary implementation of the method of FIG. 6, according to one or more embodiments.

FIG. 7B schematically illustrates another exemplary implementation of the method of FIG. 6, according to one or more embodiments.

FIG. 8 illustrates a method for sealing a wellbore wall, according to one or more embodiments.

FIG. 9 schematically illustrates an exemplary implementation of the method of FIG. 8, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Illustrative examples of the subject matter claimed below will now be disclosed. In the interest of clarity, not all features of an actual implementation are described in this specification. It will be appreciated which in the development of any such actual implementation, numerous implementation-specific decisions may be made to achieve the developers' specific goals, such as compliance with system-related and business-related constraints, which will vary from one implementation to another. Moreover, it will be appreciated which such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

For the sake of brevity, all similar components have been given similar reference numbers with the same last two digits and a full description of such similar components may not be repeated herein. Similarly, for the sake of brevity, all like components have been given the same reference numbers, and a full description of such components may not be repeated herein.

Aspects of the present disclosure provide systems and methods for sealing a well including positioning a tool within a wellbore at a desired depth, emitting electromagnetic radiation towards geological material within the wellbore, melting at least a portion of the geological material with the electromagnetic radiation, and sealing at least a portion of the wellbore with the melted geological material.

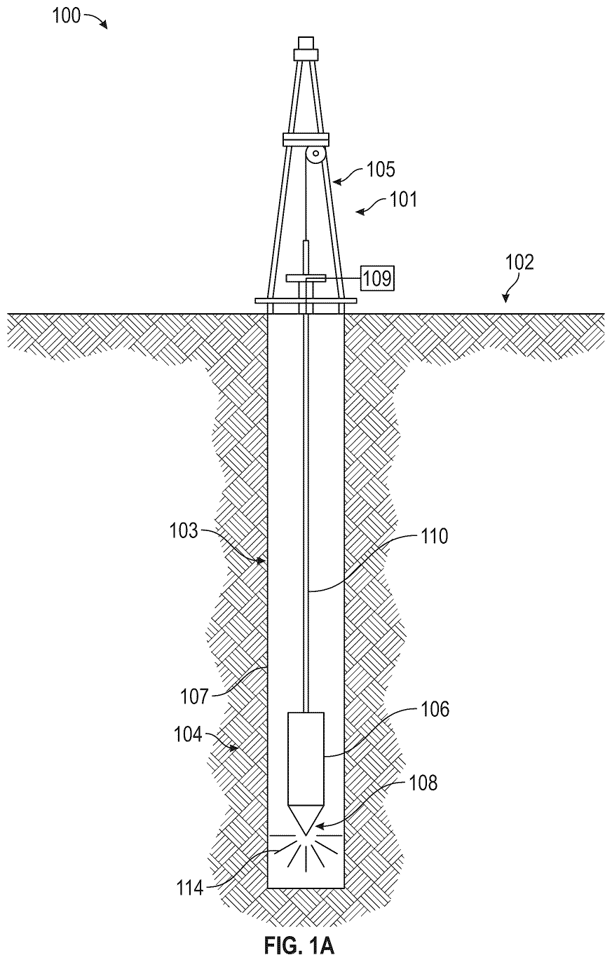

FIG. 1A illustrates an exemplary well-sealing system 100. The well-sealing system 100 includes surface equipment 101 disposed on a surface 102 above a wellbore 103 formed in a geologic formation 104.

The surface equipment 101 includes a support system 105 for lowering and/or raising a tool 106 into and out of the wellbore 103. The tool 106 is used to seal at least a portion of the wellbore 103.

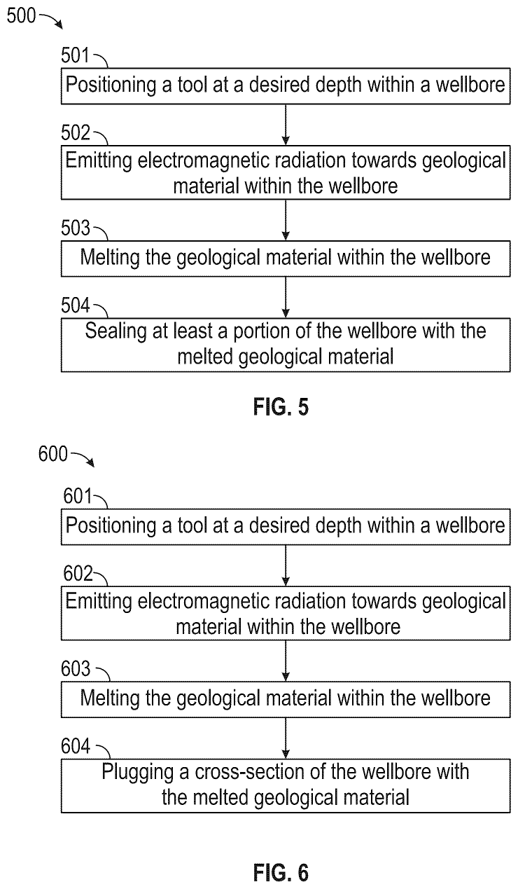

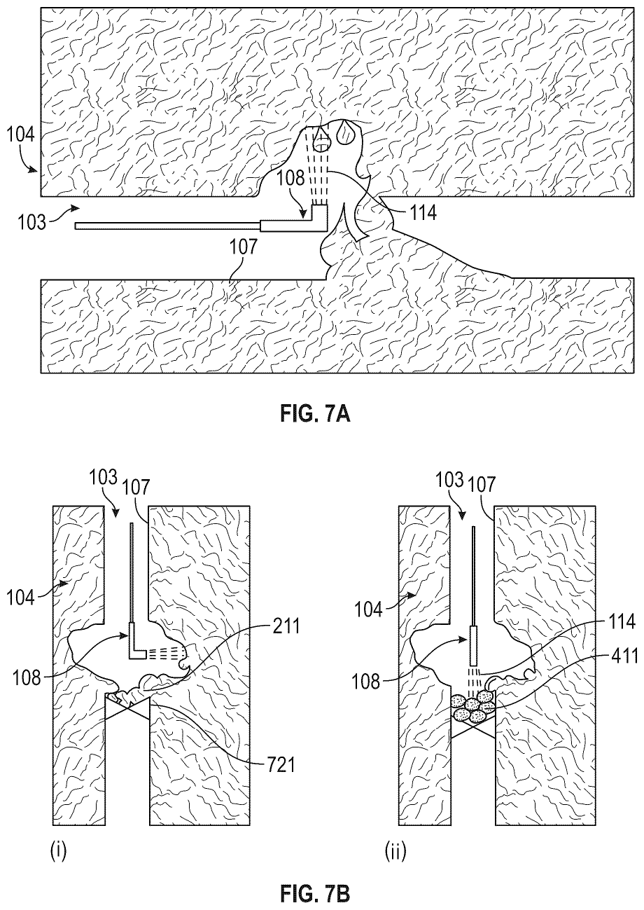

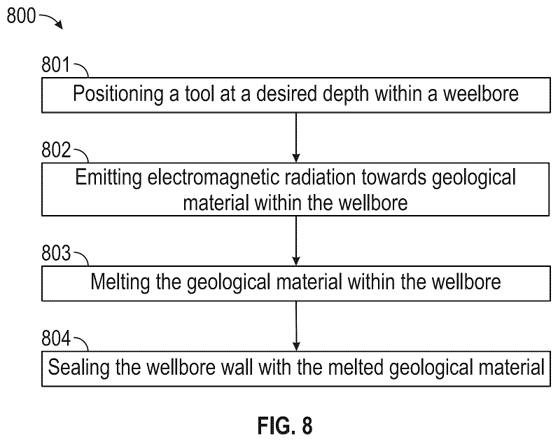

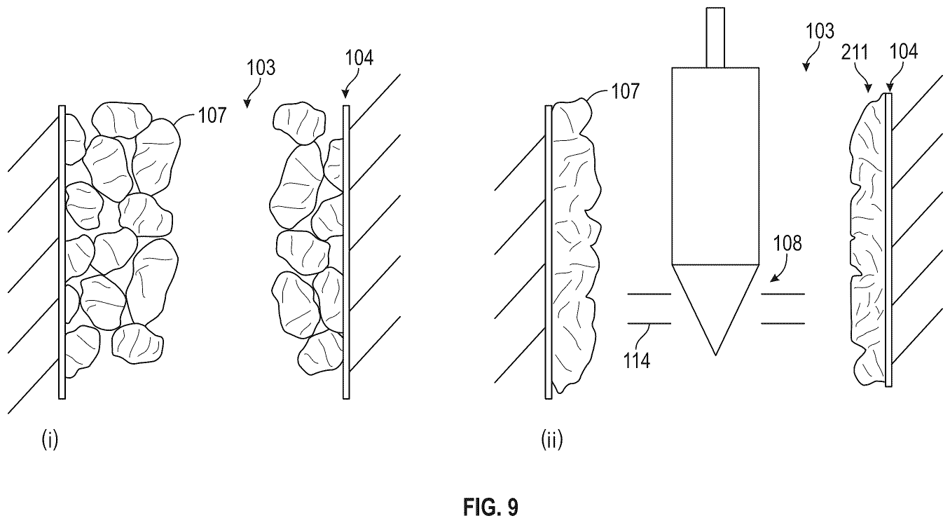

In some embodiments, (e.g., those illustrated in FIGS. 6-7B) sealing at least a portion of the wellbore 103 may include permanently sealing off individual zones or the entire wellbore 103 to prevent all hydraulic communication between the zones or between the sealed-off zones and the surface 102 (e.g., plugging). In some embodiments (e.g., those illustrated in FIGS. 8-9), sealing at least a portion of the wellbore 103 includes glazing of the wellbore wall 107 to prevent ingress and egress of fluids from the formation into the wellbore and vice versa.

The tool 106 includes a radiation emitting device 108. The radiation emitting device 108 is configured to emit electromagnetic radiation 114. While the embodiment shown in FIGS. 1A and 1B illustrate the radiation emitting device 108 as being at the end of the tool 106, it is understood that the radiation emitting device 108 may be on any portion of the tool 106.

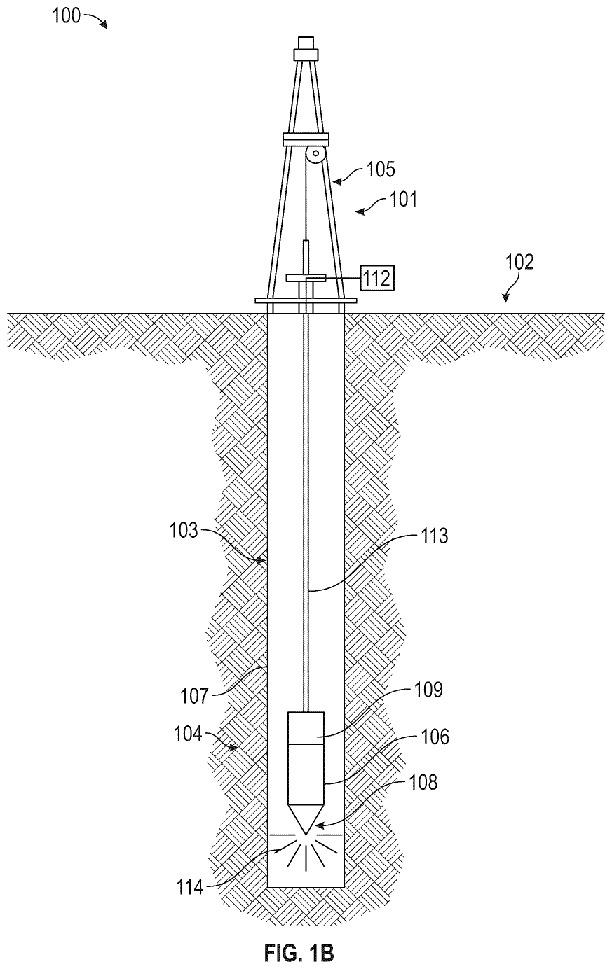

The radiation emitting device 108 emits electromagnetic radiation 114 to a target depth where a seal is to be placed. The electromagnetic radiation 114 is easily absorbed by geological material (e.g., ground formations such as geological formation 104 and/or geological debris such as rock debris, sand, etc.), thus efficiently delivering the energy they carry directly to the matrix. As the matrix heats, the geological material will melt and fill in porosity in the geological material. FIGS. 2A-2B schematically illustrate radiation emitting device 108 emitting electromagnetic radiation 114 to melt geological material 211. As the geological material melts, the melted material can be used to seal at least a portion of the wellbore 103.

As one non-limiting example, melting the wellbore wall 107 glazes and seals the wellbore wall 107 to prevent ingress and egress of fluids from the formation into the wellbore and vice versa. As another non-limiting example, melting the wellbore wall 107 may cause molten geological material to fill in the wellbore 103 thus sealing the wellbore 103 and/or isolating a zone of the wellbore 103. In yet another non-limiting example, melting geological material in the wellbore 103 can fill in the wellbore 103 thus sealing the wellbore 103 and/or isolating a zone of the wellbore 103

The radiation emitting device 108 focuses and distributes the electromagnetic radiation 114 towards the geological material. In one or more embodiments, the radiation emitting device 108 is configured to emit electromagnetic radiation 114 radially in the wellbore 103 (e.g., towards the wellbore wall 107). In one or more embodiments, the radiation emitting device 108 is configured to emit electromagnetic radiation 114 axially in the wellbore 103 (e.g., along a central axis of the wellbore 103). In one or more embodiments, the radiation emitting device 108 is multidirectional. In one or more embodiments, the direction in which the radiation emitting device 108 emits electromagnetic radiation 114 is adjustable.

In one or more embodiments, the electromagnetic radiation 114 emitted by the radiation emitting device 108 includes radiation 114 in the range of frequencies from about 300 MHz to about 300 GHz. For instance, the electromagnetic radiation 114 may be microwaves. In one or more embodiments, the electromagnetic radiation 114 may be millimeter waves (in a frequency range of 30 GHz to 300 GHz). In one or more embodiments, the radiation emitting device 108 emits radiation 114 with multiple frequencies and/or emits a series of radiation pulses 114 with the same or different frequencies. For example multi-frequency operation may be used for ‘curing’ the geological material during the cooling process to avoid sudden thermal expansion-contraction cycle which could result in crack development. In one or more embodiments, higher frequency could be used to melt the rock, while lower and thus deeper-penetrating frequency, could be used to more gently warm and cool the rock behind the melted region.

The electromagnetic radiation 114 emitted by the radiation emitting device 108 is generated via a radiation generator 109. In the embodiment shown in FIG. 1A, the radiation generator 109 is located at the surface 102 (i.e., is a part of the surface equipment 101). In the embodiment shown in FIG. 1A, the radiation generator 109 generates the electromagnetic radiation 114 and transmits it downhole to the radiation emitting device 108 via a specially engineered radiation transmitter 110. In one or more embodiments, the radiation transmitter 110 is a waveguide 110 (hereinafter referred to as “waveguide 110). In one or more embodiments, the waveguide 110 is designed for maximum power transfer efficiency for the particular wavelength used. The waveguide 110 is also configured to endure the harsh downhole environment to ensure it can be lowered into the wellbore and survive the shock and vibrations, as well as the downhole pressures and temperatures. Accordingly, in one or more embodiments, the waveguide 110 can be sheathed, insulated, or otherwise armored similar to sheathed fiber optic cables used in oil-and-gas wells, both inside the casing and buried in cement.

In the embodiment shown in FIG. 1B, the radiation generator 109 is located downhole. As a non-limiting example, the radiation generator 109 may be coupled to, or a portion of, the tool 106. In such embodiments, the radiation generator 109 may be lowered with the remainder of the tool 106. In such embodiments, the surface equipment 101 includes a power source 112. The power source 112 is electrically coupled to the radiation generator 109. In the presently illustrated embodiment, the power source 112 is coupled to the radiation generator 109 via a power cable 113. However, any method of delivering electrical power downhole is possible. For instance, fluid flow may be used to generate electrical power downhole through the use of a turbine (e.g., a turbine alternator) in the wellbore 103. According to one mode of operation, the power source 112 supplies power (e.g., electrical power) to the radiation generator 109, the radiation generator 109 generates the electromagnetic radiation 114 downhole, and the radiation emitting device 108 emits said electromagnetic radiation 114. In one or more embodiments, the radiation generator 109 located on, or as a part of, the tool 106 is coupled to the radiation emitting device 108 by a short section of a waveguide.

In one or more embodiments, the radiation generator 109 may be any radiation generating device capable of generating radiation in the frequency of between about 300 MHz to about 300 GHz. In one more or more embodiments, the radiation generator 109 may be capable of multi-frequency radiation generation (i.e., the radiation generator 109 is capable of generating radiation of different frequencies). In one or more embodiments, the radiation generator 109 is one or more of a gyrotron (e.g., a 100 kW gyrotron), a klystron, a magnetron, and/or traveling wave tube.

In one or more embodiments, the type of radiation generator 109 and frequency of the electromagnetic radiation 114 may be optimized for particular wellbores 103 and/or operations (e.g., plugging and/or sealing the wellbore wall 107 as discussed below).

In one or more embodiments, optimizing the type of radiation generator 109 and/or frequency of the electromagnetic radiation 114 includes taking into account the mineralogy and other petrophysical properties of the targeted geological material (e.g., geological formation 104). According to one example, the mineralogy and other petrophysical properties include porosity, rate of melting, and/or flowability. In one or more embodiments, optimizing the type of radiation generator 109 and/or frequency of the electromagnetic radiation 114 includes optimizing the electromagnetic radiation 114 for a desired penetration depth.

Accordingly, the frequency or simultaneous frequencies, or sequence of frequencies used, can be based on an optimization algorithm that takes into account available petrophysical, geological, or geophysical information about the wellbore 103. In one or more embodiments, assessing the wellbore 103 may include running a downhole dielectric constant assessment tool.

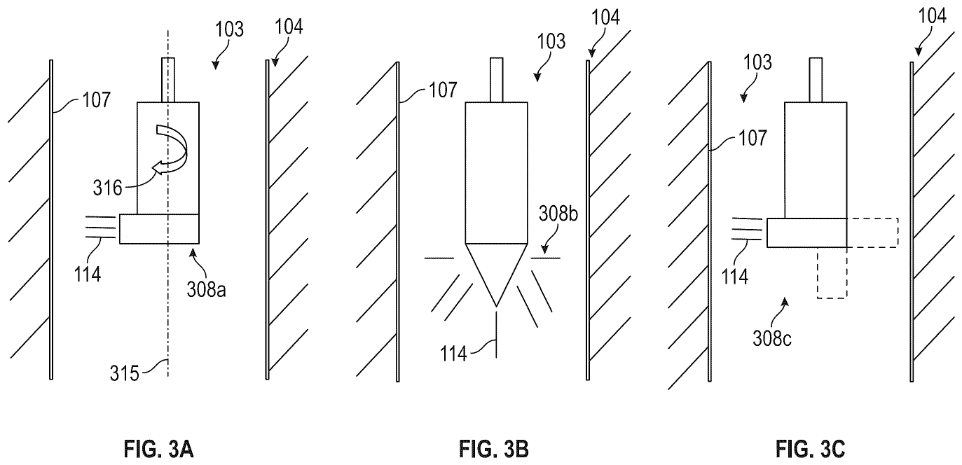

In one or more embodiments, and as discussed below, the optimization algorithm may also be used to determine where the wellbore 103 is to be sealed and whether supplying additional geological material to be melted (as discussed below with regard to FIG. 4), is appropriate.

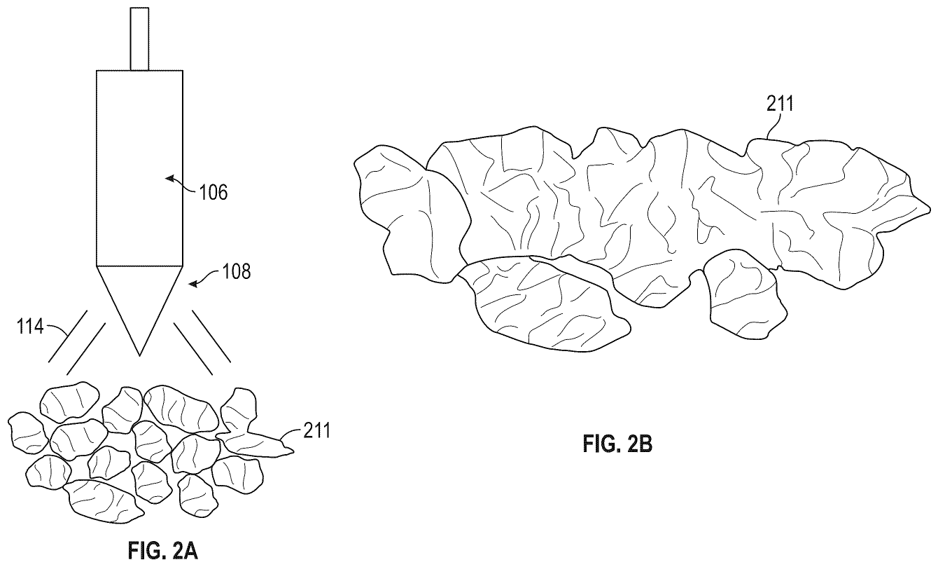

FIGS. 3A-3C illustrate exemplary radiation emitting devices 308a, 308b, 308c. FIG. 3A illustrates an exemplary radiation emitting device 308a configured to emit electromagnetic radiation 114 in one direction. In one or more embodiments, the radiation emitting device 308a emits radiation 114 in a radial direction (e.g., towards the wellbore wall 107). In one or more embodiments, the radiation emitting device 308a emits radiation 114 in an axial direction (e.g. along a central axis of the wellbore 103). In one or more embodiments, the radiation emitting device 308a emits radiation 114 between radially and axially (i.e., at an angle between about 0 degrees and about 180degrees from the central axis 315). In one or more embodiments, the radiation emitting device 308a is movable such that the radiation 114 is emitted in a single direction, but the device 308a moves to aim the radiation 114 in multiple directions. For example, as illustrated, the radiation emitting device 308a may rotate about its central axis 315 (e.g., in direction 316) allowing the circumference of the wellbore wall 107 to be irradiated. In one or more embodiments, the radiation emitting device 308a may pivot or rotate about another axis.

FIG. 3B illustrates an exemplary radiation emitting device 308b configured to emit electromagnetic radiation 114 in multiple directions. In one or more embodiments, the radiation emitting device 308b emits radiation 114 in one, two, three, four, or more directions. In one or more embodiments, and as illustrated, the radiation emitting device 308b emits radiation 114 in many directions such that there is a cone, hemisphere, or sphere of radiation 114 emitted from the radiation emitting device 308b.

FIG. 3C illustrates an exemplary radiation emitting device 308c configured to emit electromagnetic radiation 114 in one or more directions, but is also flexible, configurable, or otherwise adjustable, so that the directions are movable. As illustrated, the radiation emitting device 308c is adjustable between the positions shown in the dashed lines. In one or more embodiments, the movable radiation emitting device 308c is also movable to move the device 308c closer to, or further away from, the wellbore wall 107 or geological material 211 to be irradiated. While illustrated as separate embodiments, it is understood that any of the described features of radiation emitting devices 308a, 308b, and 308c, can be in whole or in part with any other features of radiation emitting devices 308a, 308b, and 308c.

FIG. 4 illustrates another exemplary well-sealing system 100 including a geological material supply system 417. In one or more embodiments, additional material (e.g., geological material 411) can be supplied to the wellbore 103 to be melted by the radiation 114 emitted by the radiation emitting device 108. In one example, the geological material 411 can be supplied radially towards the wellbore wall 107 and melted to the wellbore wall 107 to seal the wellbore wall 107. In another example, the geological material 411 can be supplied radially towards the wellbore wall 107 and melted as it moves down the wellbore wall 107 to plug the wellbore 103. In yet another example, the geological material 411 can be supplied axially along a centerline of the wellbore 103 to plug the cross-section of the wellbore 103. In one or more embodiments, the geological material 411 is irradiated as it is delivered (e.g., sprayed) such that it melts before hitting the wellbore wall 107 or targeted location or just after.

The geological material 411 can be any material that is meltable (e.g., becomes flowable) with the above-described electromagnetic radiation 114. For example, the geological material 411 may include rock, sand, gravel, basalt, granite pellets (coarse or fine), or pellets of other geological-type material that can be melted with the above- described electromagnetic radiation 114.

In one or more embodiments, the geological material supply system 417 supplies geological material 411 to a geological material emitting device 418 from a geological material supply 419 via a supply tube 420. While illustrated as a separate component and located at the surface 102, it is contemplated that the geological material supply 419 may be part of the tool 106 being lowered into the wellbore 103. The geological material emitting device 418 can be a part of, coupled to, or distinct from the tool 106. In one or more embodiments, the geological material emitting device 418 can emit geological material 411 in the same direction as the radiation emitting device 108. In one or more embodiments, the geological material emitting device 418 can be lowered with or separately from the tool 106.

While the geological material supply system 417 is illustrated as having a supply 419, a geological material emitting device 418 and a supply tube 420, it is contemplated that the geological material supply system 417 may simply include supplying (e.g., dumping) geological material 411 into the wellbore 103 from anywhere (e.g., at or near the surface 102 or any location within the wellbore 103).

The geological material supply system 417 may be particularly useful in wellbores 103 including rock or geological material already in the wellbore 103 (e.g., the wellbore wall 107 or geological formation 104) comprises material that does not melt or is not conducive to use for sealing and/or plugging.

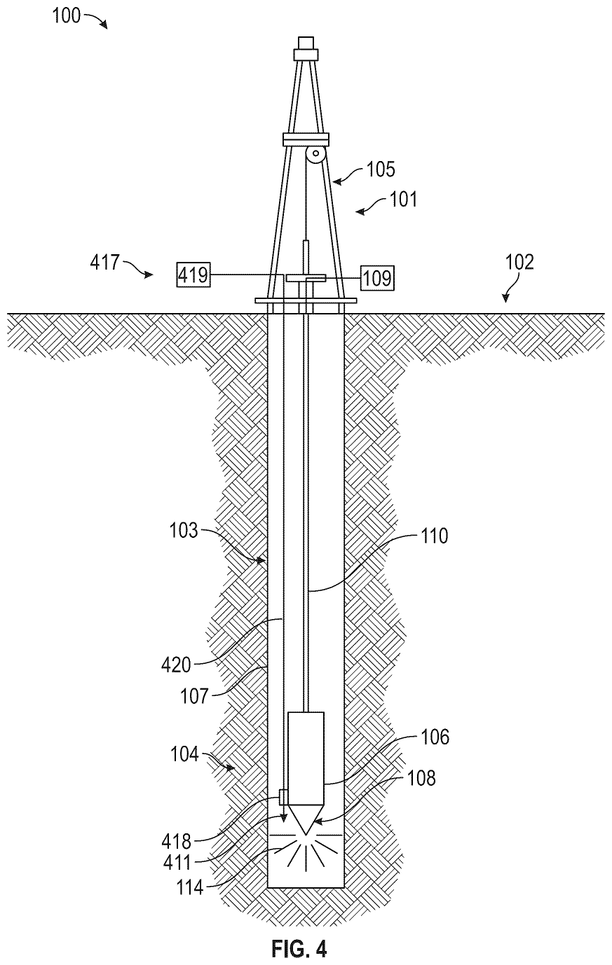

FIG. 5 illustrates a method 500 for sealing a wellbore (such as wellbore 103). The method 500 applies to both plugging a wellbore (as further described in FIG. 6 with respect to method 600) and sealing a wellbore wall (as further described in FIG. 8 with respect to method 800). At operation 501, a tool (such as tool 106) is positioned at a desired depth within the wellbore. At operation 502, a radiation emitting device (such as radiation emitting device 108) emits electromagnetic radiation (such as electromagnetic radiation 114) towards geological material within the wellbore. At operation 503, the geological material within the wellbore is melted. At operation 504, the melted geological material solidifies sealing at least a portion of the wellbore. A more detailed description of the method of 500 and exemplary embodiments of method 500 are described in more detail below with respect to FIGS. 6-10.

In one or more embodiments, before positioning the tool at the desired depth within the wellbore, operational parameters are determined. In one or more embodiments, determining operational parameters includes determining one or more of a frequency of the electromagnetic radiation to be emitted and/or the depth at which to position the tool.

In one or more embodiments, determining the frequency of the operational parameters includes optimizing the frequency (or frequencies) based on one or more of petrophysical, geological, or geophysical information about the geological material to be melted via either direct measurements, sample collection, offset (e.g., nearby) wells, or understanding of the geological material. As an example petrophysical, geological, or geophysical information about the geological material to be melted may require that the electromagnetic radiation have a particular frequency, multiple frequencies, or a particular sequence of frequencies. In one or more embodiments, determining the frequency of the operational parameters includes optimizing the frequency (or frequencies) based on desired penetration depth of the electromagnetic radiation or the desired flow rate, desired melt rate, or desired hardening rate of the melted geological material.

In one or more embodiments, determining the depth at which to position the tool includes determining that a certain depth within the wellbore is optimal for scaling. In one or more embodiments, determining that a certain depth within the wellbore is optimal for scaling includes optimizing the depth based on one or more of petrophysical, geological, or geophysical information about the geological material to be melted via either direct measurements, sample collection, offset (e.g., nearby) wells, or general geological understanding of the geological material. For example, in one or more embodiments, plugging a wellbore is optimal at a location in the wellbore including an impermeable cap rock, that may be an induced impermeable cap rock or may be one already existing.

In one or more embodiments, before positioning the tool at the desired depth within the wellbore, the wellbore may be prepared for the radiation emitting device to emit electromagnetic radiation towards the geological material.

In one or more embodiments, preparing the wellbore includes removing any strings or downhole components already disposed in the well, such as by milling out. In one or more embodiments, the downhole components (e.g., casing) is not removed and the melted geological material may not be optimally sealing, but may be ideal for controlling fluid (e.g., well fluid or water) flow through the zone.

In one or more embodiments, preparing the wellbore includes injecting a section, or the whole wellbore 103 with a substance or medium with low power absorption, or penetration depth of one centimeter or longer at the frequency of the electromagnetic radiation. In one or more embodiments, the In one or more embodiments, injecting such a substance or medium includes fluidly isolating the section so as to not inject the substance or medium into another section of the wellbore (e.g., isolating by packers). In one or more embodiments, the substance or medium includes, but is not limited to, one or more of air, nitrogen, noble gases (e.g., argon or helium), or liquids (e.g., diesel or other light hydrocarbons). Injecting such a substance or medium into the wellbore or section of the wellbore replaces (e.g., pumps out) any fluid or substance preexisting in the wellbore that may hinder the electromagnetic radiation from melting the geological material (e.g., the preexisting fluid or substance may have a high power absorption at the frequency of the electromagnetic radiation and may absorb at least a portion of the electromagnetic radiation hindering the ability of the radiation to melt the geological material).

FIG. 6 illustrates a method 600 for plugging a wellbore (such as wellbore 103). FIGS. 7A and 7B schematically illustrate implementations of method 600. As a non-limiting example, plugging the wellbore includes filling and sealing the cross-section of the wellbore at a desired depth with melted geological material (e.g. the wellbore wall 107 or added geological material, such as by the geological material supply system 417 of FIG. 4) to prevent fluid flow and/or communication across the sealed cross-section (i.e. the plug).

At operation 601, a tool (such as tool 106) is positioned at a desired depth within the wellbore. The desired depth includes a depth that is to be plugged. In one or more embodiments, the desired outcome is to permanently plug or seal the well. In one or more embodiments, the desired outcome is to isolate zones of the well and the desired depth is the area between the zones to be isolated. In one or more embodiments, the desired depth is a location in the wellbore with a section of impermeable rock cap. In such embodiments, plugging at the impermeable rock cap seals off communication between the zones.

At operation 602, a radiation emitting device (such as radiation emitting device 108) emits electromagnetic radiation (such as electromagnetic radiation 114) towards geological material within the wellbore.

In one or more embodiments, the radiation emitting device emits electromagnetic radiation radially at the wellbore wall (such as wellbore wall 107). In one or more embodiments, the radiation emitting device is moved around to irradiate fresh sections of the wellbore wall to avoid evaporating the melted geological material. However, in some embodiments, this may not be necessary, depending on the local topology of the wellbore.

At operation 603, the geological material is melted within the wellbore and, at operation 604, the melted geological material plugs a cross-section of the wellbore.

In one or more embodiments, the melted geological material will drip down under gravity, exposing fresh matrix. The geological material is melted until a sufficiently deep cavity in the wellbore wall has been melted all around the wellbore wall to extend beyond the zone of damaged formation. This zone, often fractured and cracked in the process of drilling the well, may extend a few inches or more into the formation and may have compromised hydraulic seal performance. It must be fully penetrated, melted, and fused in order to ensure a good seal. As the radiation emitting device moves to a new section, it leaves behind a fully glazed and sealed rock, with all the cracks and formation damage permanently sealed off, in the process we call ‘reconstituting’ the cap rock.

For example, as shown in FIG. 7A, in a highly deviated well 103, as the melted wellbore wall 107 drips from the top section of the wellbore 103, it will solidify and fill in the wellbore 103, sealing the wellbore 103 (e.g., plugging the wellbore 103).

In another example, as shown in FIG. 7B, in a less inclined or vertical wellbore 103, the process may take longer as the melted geological material 211 will drip down the wellbore wall 107.

In such circumstances, it may be preferable to first place a packer (such as packer 721 of FIG. 7B) below the target zone, prior to the melting process of operation 603. The melted geological material 211 will flow down to the packer 721 top surface and pool there, solidifying and developing a permanent bond across the wellbore 103. In fact, in one embodiment of the present invention, a packer 721 is always placed right below the target zone, regardless of the wellbore deviation.

As illustrated in FIG. 7B (i), in one or more embodiments, the wellbore wall 107 may be utilized as the geological material 211 to plug the wellbore 103. However, as illustrated in FIG. 7B (ii), in one or more embodiments, in order to ensure sufficient seal of the wellbore itself, especially in larger wellbores, instead of relying on the melted wellbore wall 107 flowing down and filling the wellbore 103, additional geological material 411 may be placed on top of the packer 721 (such as by geological material supply system 417 of FIG. 4), or can be a part of the packer 721, which is to be melted and fused once the wellbore wall 107 has been properly penetrated, melted and glazed as described above.

FIG. 8 illustrates a method 800 for sealing a wellbore wall (such as wellbore wall 107). FIG. 9 schematically illustrates an implementation of method 800. As a non-limiting example, sealing the wellbore wall includes melting geological material (e.g., the wellbore wall or added geological material) such that when the melted geological material solidifies, it fills in porosity and glazing and sealing the wellbore wall preventing fluid communication across the wellbore wall.

At operation 801, a tool (such as tool 106) is positioned at a desired depth within the wellbore. The desired depth includes a depth where the wellbore wall sealing is desired.

At operation 802, a radiation emitting device (such as radiation emitting device 108) emits electromagnetic radiation (such as electromagnetic radiation 114) radially towards the wellbore wall (such as wellbore wall 107). In one or more embodiments, the radiation emitting device is continuously moved around to irradiate fresh sections of the wellbore wall while avoiding penetrating deeply.

In one or more embodiments, additional geological material (such as geological material 411) is supplied to the wellbore wall while the radiation emitting device 108 emits electromagnetic radiation. In such embodiments, it may be necessary to supplement or add the geological material if the wellbore wall comprises material that is not conducive to melting and/or sealing.

At operation 803, geological material, whether it be the wellbore wall or added geological material, is melted within the wellbore and, at operation 804, the melted geological fills in the pore space, hardens, and leaves a glazed impermeable surface. FIG. 9 (i) illustrates a wellbore 103 including a porous wellbore wall 107 to be sealed and FIG. 9 (ii) illustrates a radiation emitting device 108 lowered into the wellbore 103 emitting electromagnetic radiation 114 and sealing the wellbore wall 107.

In one or more embodiments, the method 800 could be performed at several stages in the well development process, either to prevent any wellbore fluids from invading the formation; or to prevent any formation fluids from entering the wellbore as currently done by casing and cementing. Production would then be enabled by perforating the glazed over borehole. Such treatment could be particularly useful in long uncased open-hole sections which are common in horizontal wells.

In one or more embodiments, the method 800 could be performed in an isolated zone to, for example, prevent, restrict, or inhibit inflow of fluids (such as water) at a particular zone of a wellbore.

Examples in the present disclosure may also be directed to a non-transitory computer-readable medium storing computer-executable instructions and executable by one or more processors of the computer via which the computer-readable medium is accessed. A computer-readable media may be any available media which may be accessed by a computer. By way of example, such computer-readable media may comprise RAM, ROM, EEPROM, CD-ROM or other optical disk storage, magnetic disk storage or other magnetic storage devices, or any other medium which may be used to carry or store desired program code in the form of instructions or data structures and which may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

### Example Aspects

Aspect 1: A method for sealing a wellbore, including: positioning a tool including a radiation emitting device in a wellbore at a desired depth, emitting electromagnetic radiation at one or more frequencies, emitting the electromagnetic radiation includes emitting the electromagnetic radiation in a radial direction towards geological material disposed in the wellbore, melting the geological material with the electromagnetic radiation, and sealing at least a portion of the wellbore with the melted geological material.

Aspect 2: the method of Aspect 1, wherein sealing the at least a portion of the wellbore with the melted geological material includes sealing a wall of the wellbore.

Aspect 3: the method of Aspect 2, wherein the geological material includes the wall of the wellbore.

Aspect 4: The method of Aspect 2, further comprising supplying the geological material to the wellbore, wherein melting the geological material includes melting at least a portion of the supplied geological material, and wherein sealing the wall of the wellbore includes sealing the wall of the wellbore with the melted portion of the geological material.

Aspect 5: The method of Aspect 1, wherein sealing the at least a portion of the wellbore with the melted geological material includes plugging a cross-section of the wellbore with the melted geological material.

Aspect 6: The method of Aspect 5, wherein the geological material includes a wall of the wellbore.

Aspect 7: The method of Aspect 6, further comprising disposing a packer in the wellbore below the desired depth, and wherein plugging the cross-section of the wellbore with the melted geological material includes pooling the melted geological material on top of the packer.

Aspect 8: The method of Aspect 5, further comprising supplying the geological material to the wellbore, wherein melting the geological material includes melting at least a portion of the supplied geological material, and wherein plugging the cross-section of the wellbore includes plugging the cross-section of the wellbore with the melted portion of the supplied geological material.

Aspect 9: The method of Aspect 8, further comprising disposing a packer in the wellbore below the desired depth, and wherein plugging the cross-section of the wellbore with the melted supplied geological material includes pooling the melted supplied geological material on top of the packer.

Aspect 10: The method of Aspect 9, wherein the packer is disposed in a casing disposed in the wellbore.

Aspect 11: The method of any of Aspects 1-10, further comprising injecting the wellbore with a medium including a penetration depth of one centimeter or longer at the one or more frequencies of the electromagnetic radiation before emitting the electromagnetic radiation.

Aspect 12, the method of any of Aspects 1-11, further comprising determining the one or more frequencies of the electromagnetic radiation, wherein the one or more frequencies are determined based on one or more of petrophysical, geological, and geophysical information about the wellbore.

Aspect 13: A system for sealing a wellbore including a radiation generator configured to generate electromagnetic radiation, a radiation transmitter coupled to the radiation generator for transmitting the electromagnetic radiation, and a radiation emitting device configured to emit the electromagnetic radiation in a radial direction towards geological material in a wellbore to melt the geological material

Aspect 14: The system of Aspect 13, wherein a downhole tool includes the radiation emitting device.

Aspect 15: The system of Aspect 14, wherein the downhole tool includes the radiation generator and the radiation transmitter, and wherein the system further includes a power supply, the power supply electrically coupled to the downhole tool and configured to power the radiation generator.

Aspect 16: The system of Aspects 13 or 14, wherein the radiation generator is disposed at a surface of the wellbore.

Aspect 17: The system of any of Aspects 13-16, wherein the radiation emitting device emits the electromagnetic radiation in an axial direction.

Aspect 18: The system of any of Aspects 13-17, wherein a direction in which the radiation emitting device emits electromagnetic radiation is movable.

Aspect 19: The system of any of Aspects 13-18, further comprising a geological material supply system including a geological material supply, a supply tube, and a geological material emitting device configured to emit geological material in same direction the radiation emitting device emits the electromagnetic radiation

Aspect 20: The system of any of Aspects 13-19, wherein the radiation generator is configured to generate electromagnetic radiation at a plurality of frequencies simultaneously or sequentially

Any one or more components of the well sealing system 100 may be integrally formed together, directly coupled together, and/or indirectly coupled together and are not limited to the specific arrangement of components illustrated in FIGS. 1-9. Any one or more of the embodiments of the well sealing system 100 may be combined in whole or part with any one or more of the embodiments of the well scaling system 100.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (c.g., accessing data in a memory) and the like. Also, “determining” may include resolving, selecting, choosing, establishing and the like.

While the present disclosure has been described with respect to a number of embodiments and examples, those skilled in the art, having benefit of this disclosure, will appreciate that other embodiments can be devised which do not depart from the scope and spirit of the present disclosure.

The preceding description, for purposes of explanation, uses specific nomenclature to provide a thorough understanding of the disclosure and is provided to enable any person skilled in the art to practice the various aspects described herein. However, it will be apparent to one skilled in the art which the specific details are not required in order to practice the systems and methods described herein. The examples discussed herein are not limiting of the scope, applicability, or aspects set forth in the claims. They are not intended to be exhaustive of or to limit this disclosure to the precise forms described. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. The examples are shown and described in order to best explain the principles of this disclosure and practical applications, to thereby enable others skilled in the art to best utilize this disclosure and various examples with various modifications as are suited to the particular use contemplated. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. It is intended which the scope of this disclosure be defined by the claims and their equivalents below.

What is claimed is:

1. A method for sealing a wellbore, comprising:
positioning a tool including a radiation emitting device in a wellbore at a desired depth;
emitting electromagnetic radiation at one or more frequencies, wherein emitting the electromagnetic radiation includes emitting the electromagnetic radiation in a radial direction towards geological material disposed in the wellbore;
melting the geological material with the electromagnetic radiation; and
sealing at least a portion of the wellbore with the melted geological material.

2. The method of claim 1, wherein sealing the at least a portion of the wellbore with the melted geological material includes sealing a wall of the wellbore.

3. The method of claim 2, wherein the geological material includes the wall of the wellbore.

4. The method of claim 2, further comprising supplying the geological material to the wellbore, wherein melting the geological material includes melting at least a portion of the supplied geological material, and wherein sealing the wall of the wellbore includes sealing the wall of the wellbore with the melted portion of the geological material.

5. The method of claim 1, wherein sealing the at least a portion of the wellbore with the melted geological material includes plugging a cross-section of the wellbore with the melted geological material.

6. The method of claim 5, wherein the geological material includes a wall of the wellbore.

7. The method of claim 6, further comprising disposing a packer in the wellbore below the desired depth, and wherein plugging the cross-section of the wellbore with the melted geological material includes pooling the melted geological material on top of the packer.

8. The method of claim 5, further comprising supplying the geological material to the wellbore, wherein melting the geological material includes melting at least a portion of the supplied geological material, and wherein plugging the cross-section of the wellbore includes plugging the cross-section of the wellbore with the melted portion of the supplied geological material.

9. The method of claim 8, further comprising disposing a packer in the wellbore below the desired depth, and wherein plugging the cross-section of the wellbore with the melted portion of the supplied geological material includes pooling the melted portion of the supplied geological material on top of the packer.

10. The method of claim 9, wherein the packer is disposed in a casing disposed in the wellbore.

11. The method of claim 1, further comprising injecting the wellbore with a medium including a penetration depth of one centimeter or longer at the one or more frequencies of the electromagnetic radiation before emitting the electromagnetic radiation.

12. The method of claim 1, further comprising determining the one or more frequencies of the electromagnetic radiation, wherein the one or more frequencies are determined based on one or more of petrophysical, geological, and geophysical information about the wellbore.

13. A system for sealing a wellbore, comprising:
a radiation generator configured to generate electromagnetic radiation;
a radiation transmitter coupled to the radiation generator for transmitting the electromagnetic radiation; and
a radiation emitting device configured to emit the electromagnetic radiation in a radial direction towards geological material in a wellbore to melt the geological material.

14. The system of claim 13, wherein a downhole tool includes the radiation emitting device.

15. The system of claim 14, wherein the downhole tool includes the radiation generator and the radiation transmitter, and wherein the system further includes a power supply, the power supply electrically coupled to the downhole tool and configured to power the radiation generator.

16. The system of claim 13, wherein the radiation generator is disposed at a surface of the wellbore.

17. The system of claim 13 wherein the radiation emitting device emits the electromagnetic radiation in an axial direction.

18. The system of claim 13, wherein a direction in which the radiation emitting device emits electromagnetic radiation is movable.

19. The system of claim 13, further comprising a geological material supply system including a geological material supply, a supply tube, and a geological material emitting device configured to emit geological material in same direction the radiation emitting device emits the electromagnetic radiation.

20. The system of claim 13, wherein the radiation generator is configured to generate electromagnetic radiation at a plurality of frequencies simultaneously or sequentially.
